(19) United States
(12) Patent Application Publication
(10) Pub. No.: US 2026/0184264 A1
(43) Pub. Date: Jul. 2, 2026

(54) BICYCLE RACK

(71) Applicant: Wayne Lockwood, Powder Springs, GA (US)

(72) Inventor: Wayne Lockwood, Powder Springs, GA (US)

(21) Appl. No.: 19/228,267

(22) Filed: Jun. 4, 2025

Related U.S. Application Data
(60) Provisional application No. 63/740,941, filed on Dec. 31, 2024.

(51) Int. Cl. B60R 9/10; B60R 9/06

(52) U.S. Cl. CPC B60R 9/10; B60R 9/06

(57) ABSTRACT

A bicycle rack can include at least one supporting member at least partially defining a slot, the slot configured to receive a bicycle; and at least one cross-member further defining the slot. The bicycle rack can further comprise a coupling member, which can be coupled to the at least one supporting member.

### CROSS-REFERENCE TO RELATED APPLICATIONS

This application claims the benefit of U.S. Provisional Application No. 63/740,941, filed on Dec. 31, 2024, which is hereby incorporated in its entirety by reference.

### TECHNICAL FIELD

This disclosure relates to bicycle racks. More specifically, this disclosure relates to bicycle racks for carrying bicycles with a vehicle.

### BACKGROUND

Bicycles are large enough that they will not easily fit into many vehicles. Bicycles are often attached externally to vehicles utilizing bicycle racks. Bicycle racks often include numerous moving parts which can fail and increase cost of manufacturing of the bicycle racks.

### SUMMARY

Disclosed is a bicycle rack comprising at least one supporting member at least partially defining a slot, the slot configured to receive a bicycle; and at least one cross-member further defining the slot.

Also disclosed is a bicycle rack assembly comprising: a bicycle rack comprising: a first supporting member; a second supporting member spaced apart from the first supporting member, a slot at least partially defined between the first supporting member and the second supporting member; a first cross-member extending at least partially between the first supporting member and the second supporting member, the first cross-member further defining the slot; a second cross-member extending at least partially between the first supporting member and the second supporting member, the second cross-member further defining the slot; a third cross-member extending at least partially between the first supporting member and the second supporting member, the third cross-member positioned within the slot between the first cross-member and the second cross-member; and a bicycle comprising a first tire and a second tire, the first tire received in the slot between the first cross-member and the second cross-member, the second tire received in the slot between the second cross-member and the third cross-member.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures may be designated by matching reference characters for the sake of consistency and clarity.

FIG. 1 is a rear view of a bicycle rack that is coupled to a vehicle in accordance with one aspect of the present disclosure.

FIG. 2 is a top view of the bicycle rack of FIG. 1.

FIG. 3 is a right side view of the bicycle rack of FIG. 1.

FIG. 4 is a left side view of the bicycle rack of FIG. 1.

FIG. 5 is a bottom view of the bicycle rack of FIG. 1 removed from the vehicle.

FIG. 6 is a rear view of the bicycle rack of FIG. 1 removed from the vehicle and positioned upside down.

FIG. 7 is a rear view of the bicycle rack of FIG. 1 holding a bicycle.

FIG. 8 is a perspective rear view of the bicycle rack of FIG. 1 holding the bicycle of FIG. 7.

FIG. 9 is a detailed view of a rear tire of the bicycle received by the bicycle rack of FIG. 1.

FIG. 10 is a detailed view of a front tire of the bicycle received by the bicycle rack of FIG. 1.

FIG. 11 is a rear perspective view of the bicycle rack of FIG. 1 coupled to the vehicle.

FIG. 12 is a right side perspective view of the bicycle rack of FIG. 1 coupled to the vehicle.

FIG. 13 is a top view of another aspect of the bicycle rack in accordance with another aspect of the present disclosure.

FIG. 14 is a top view of another aspect of the bicycle rack in accordance with another aspect of the present disclosure.

FIG. 15 is a rear perspective view of another aspect of the bicycle rack coupled to the vehicle in accordance with another aspect of the present disclosure.

FIG. 16 is a side perspective view of the bicycle rack of FIG. 15 coupled to the vehicle.

FIG. 17 is a rear perspective view of the bicycle rack of FIG. 15 holding a bicycle and coupled to the vehicle.

### DETAILED DESCRIPTION

Disclosed is a bicycle rack and associated methods, systems, devices, and various apparatus. The bicycle rack can comprise a first supporting member, a second supporting member, a coupling member, and at least one cross-member. It would be understood by one of skill in the art that the disclosed bicycle rack is described in but a few exemplary embodiments among many. No particular terminology or description should be considered limiting on the disclosure or the scope of any claims issuing therefrom.

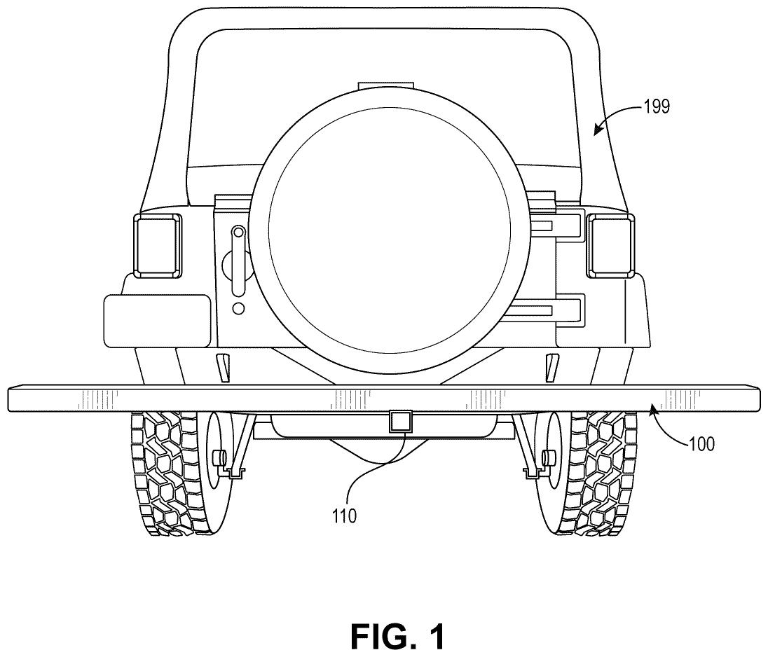

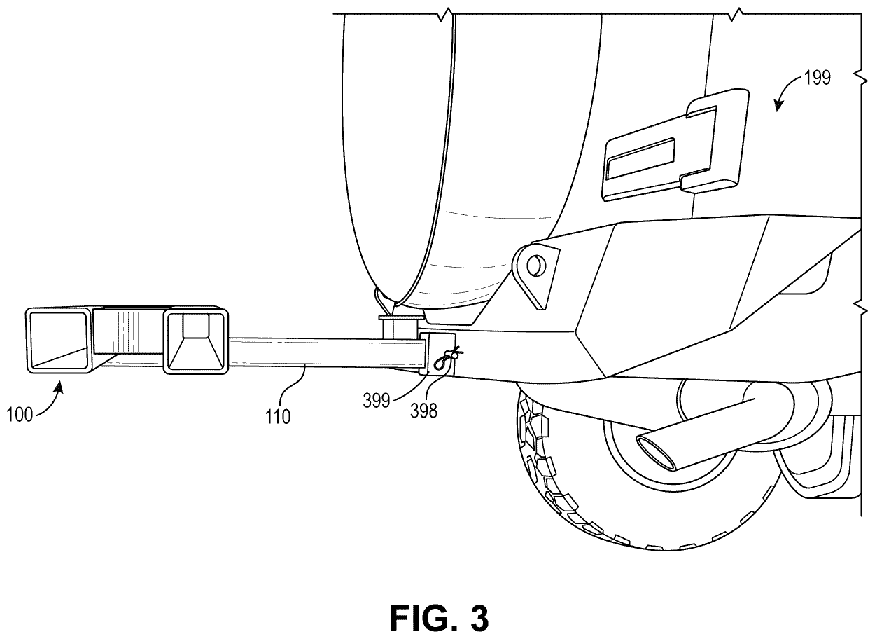

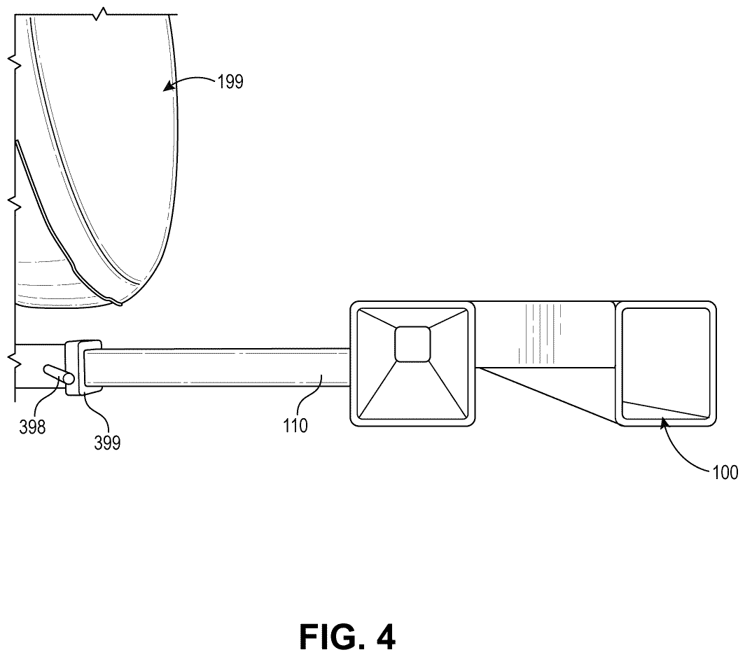

One aspect of a bicycle rack 100 is disclosed and described in FIG. 1. The bicycle rack 100 can be configured to couple to a vehicle 199. As shown in FIGS. 1-4, the bicycle rack 100 can comprise a coupling member 110, which can couple to the vehicle 199. In the aspect shown, the coupling member 110 can be sized and shaped to be received by a receiver hitch 399 (shown in FIGS. 3 and 4) of the vehicle 199, although this should not be viewed as limiting. For example and without limitation, the coupling member 110 can comprise square tubing material, though the dimensions of the coupling member 110 can vary to conform to receiver hitches 399 of various dimensions. In the aspect shown, the coupling member 110 can comprise 2″×2″ square tubing for example and without limitation. In various aspects, the bicycle rack 100 can be configured to couple to the vehicle 199 in any suitable manor, and the coupling member 110 can comprise straps, fasteners, hooks, or other components or combinations thereof.

As shown in FIGS. 3 and 4, the coupling member 110 can be secured in the receiver hitch 399 of the vehicle 199 by a pin 398. The pin 398 can extend through aligned holes (not shown) in the receiver hitch 399 and the coupling member 110 to prevent withdrawal of the coupling member 110 from the receiver hitch 399.

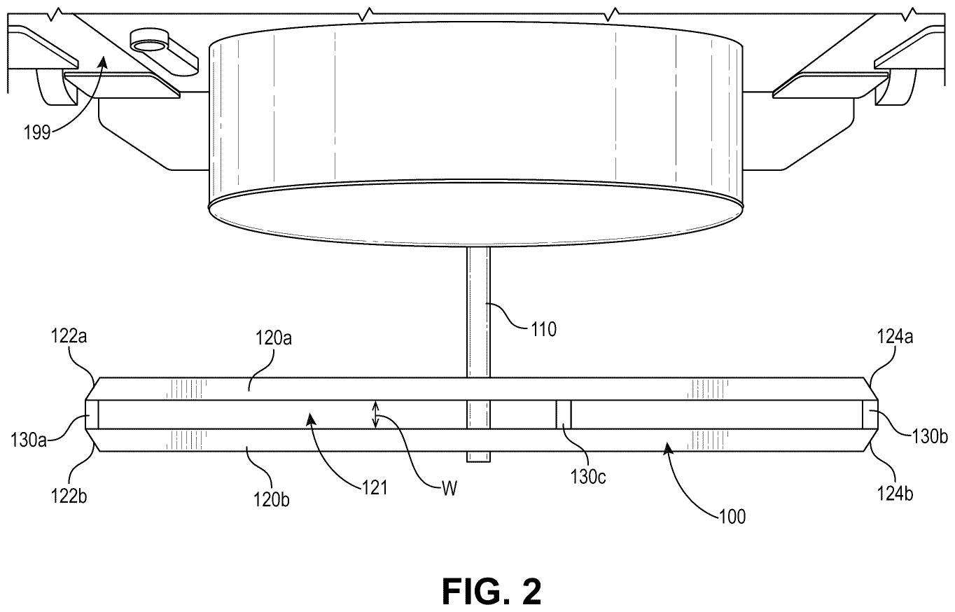

As shown in FIG. 2, the bicycle rack 100 can further comprise at least one supporting member 120. In the present aspect, the bicycle rack 100 can comprise a first supporting member 120a and a second supporting member 120b. In the aspect shown, the first supporting member 120a can be substantially parallel to the second supporting member 120b. In the present aspect, the coupling member 110 can be substantially perpendicular to the first supporting member 120a and the second supporting member 120b. In the present aspect, the coupling member 110 can be coupled to the first supporting member 120a and/or the second supporting member 120b. A width W can be defined by a slot 121 extending between the supporting members 120a,b. The width W can be substantially constant; however, in some aspects, the width W can vary along the length of the supporting members 120a,b, such as to define wider and narrower portions of the slot 121 therebetween, for example and without limitation.

In the present aspect, the supporting members 120a,b can comprise tubing, such as square or rectangular tubing for example and without limitation. In some aspects, the supporting members 120a,b can comprise a different material, such as rods, angle shapes, bar stock, channels, beams, or any other type of suitable material. In the aspect shown, the supporting members 120a,b can be hollow 2″×2″ square tubes. In some aspects, the first supporting member 120a can comprise a different material than the second supporting member 120b. For example and without limitation, in some aspects, one supporting member 120 can comprise square or rectangular tubing while the other supporting member 120 can comprise a flat bar of material.

The bicycle rack 100 can further comprise at least one cross-member 130. In some aspects, the at least one cross-member 130 can further define the slot 121. In the present aspect, the bicycle rack 100 can comprise a first cross-member 130a, a second cross-member 130b, and a third cross-member 130c, though this should not be viewed as limiting. The cross-members 130a,b,c can extend between the supporting members 120a,b and can be coupled to the supporting members 120a,b. In some aspects, the cross-members 130 can be adjusted or interchanged with cross-members 130 of different dimensions to adjust the width W of the slot 121 (shown in FIG. 4). In some aspects, one or more of the cross-members 130 may not extend the entire width W between the supporting members 120a,b.

As shown in FIG. 2, the first cross-member 130a can be positioned at the first ends 122a,b of the first supporting member 120a and the second supporting member 120b, respectively. The second cross-member 130b can be positioned at the second ends 124a,b of the first supporting member and the second supporting member 120b, respectively. The third cross-member 130c can be positioned within the slot 121 between the first and second cross-members 130a,b. In some aspects, one or more of the cross-members 130 can be defined by a separate piece of material than the supporting members 120. For example and without limitation, in aspects wherein the supporting members 120a,b are defined by pieces of tubing, one or more of the cross-members 130 can be defined by a separate piece of material extending between the tubes of the supporting members 120a,b. In some aspects, one or more of the cross-members 130 can be defined by the same material defining supporting tube 120a and/or 120b. For example and without limitation, in aspects wherein the supporting members 120a,b are defined by pieces of tubing, the tubing can be shaped to define one or more of the cross-members 130, such as by bending portions of the tubes. As a further example, in some aspects where tubes define the supporting members 120a,b, the tubes can be bent towards one another at the ends 122a,b and/or 124a,b and possibly connected together to define cross-member 130a and/or cross-member 130b, respectively. As a further example, in some aspects where tubes define the supporting members 120a,b, the tubes can be bent towards one another and possibly connected to define the cross-member 130c.

In the present aspect, bicycle rack 100 can comprise no moving parts. For example and without limitation, the coupling member 110, supporting members 120a,b and cross-members 130 can be welded together; however, this should not be viewed as limiting. For example and without limitation, any of the various members 110,120,130 can be coupled together with fasteners, welds, interlocking joints, adhesives, or other suitable methods or combinations thereof. In some aspects, one or more cross-members 130 can be moveable and/or removable.

In the present aspect, the bicycle rack 100 can comprise a metal, such as steel, aluminum, titanium, or another other metal. In various aspects, the bicycle rack 100 can comprise different materials such as wood, carbon fiber, plastics, composites, or other suitable materials or combinations thereof.

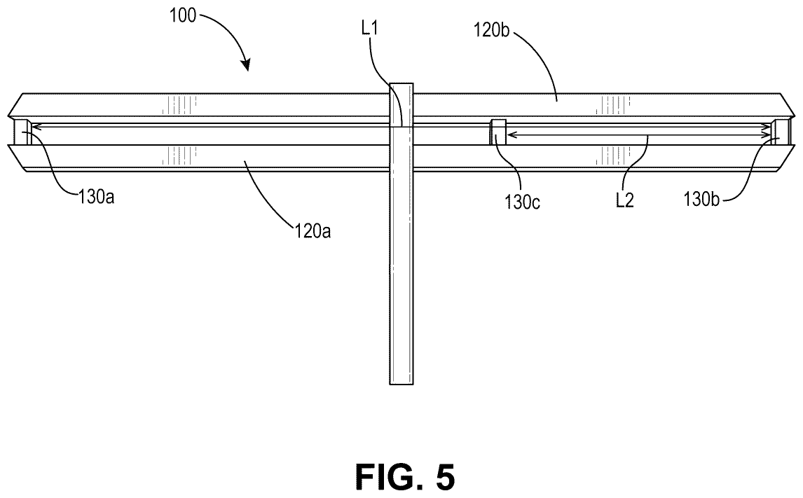

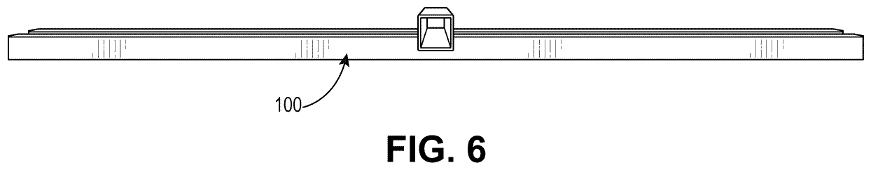

FIG. 5 is a bottom view of the bicycle rack 100 of FIG. 1. FIG. 6 is a rear view of the bicycle rack 100 of FIG. 1 in the upside-down position shown in FIG. 5. As shown in FIG. 5, a first length L1 can be defined extending between the first cross-member 130a and the second cross-member 130b. A second length L2 can be defined extending between the second cross-member 130b and the third cross-member 130c. In some aspects, one or more of the cross-members 130a,b can be moved relative to the supporting members 120a,b to adjust the first length L1 and/or the second length L2. In some aspects, lengths of the supporting members 120a,b can be adjustable to adjust the first length L1 and/or the second length L2. For example and without limitation, the supporting members 120a,b can each comprise multiple telescoping pieces capable of lengthening and shortening in some aspects.

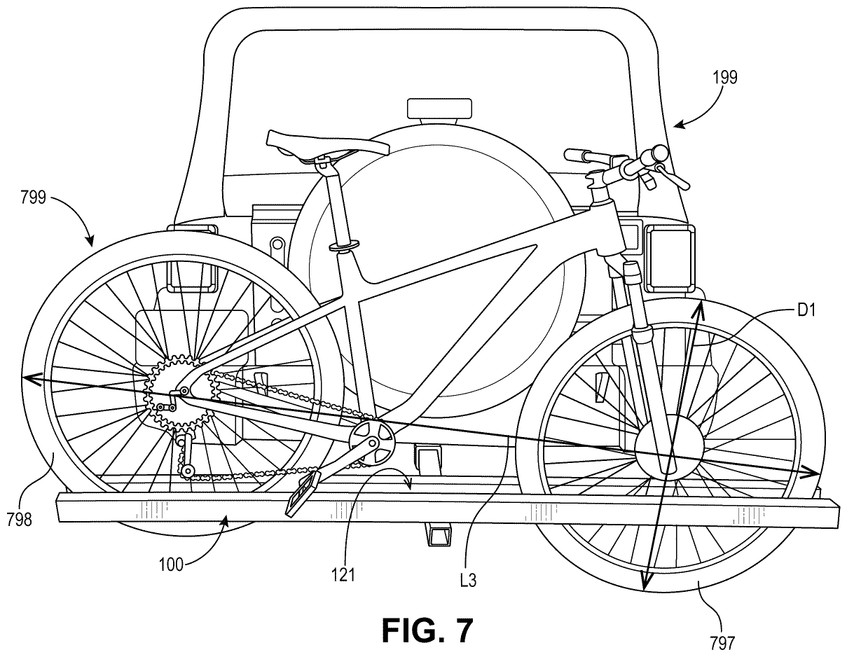

FIG. 7 is a rear view of the bicycle rack 100 of FIG. 1 coupled to the vehicle 199 of FIG. 1 with a bicycle 799 secured in the bicycle rack 100. As shown, the front tire 797 and the rear tire 798 of the bicycle 799 can fit within the slot 121. Preferably, the width W (shown in FIG. 4) of the slot 121 can be sized to snuggly grip the tires 797,798 to retain the bicycle 799 in the bicycle rack 100. A length L3 of the bicycle 799 can be defined between the furthest apart portions of the front tire 797 and the rear tire 798, respectively. The front tire 797 can define a diameter D1.

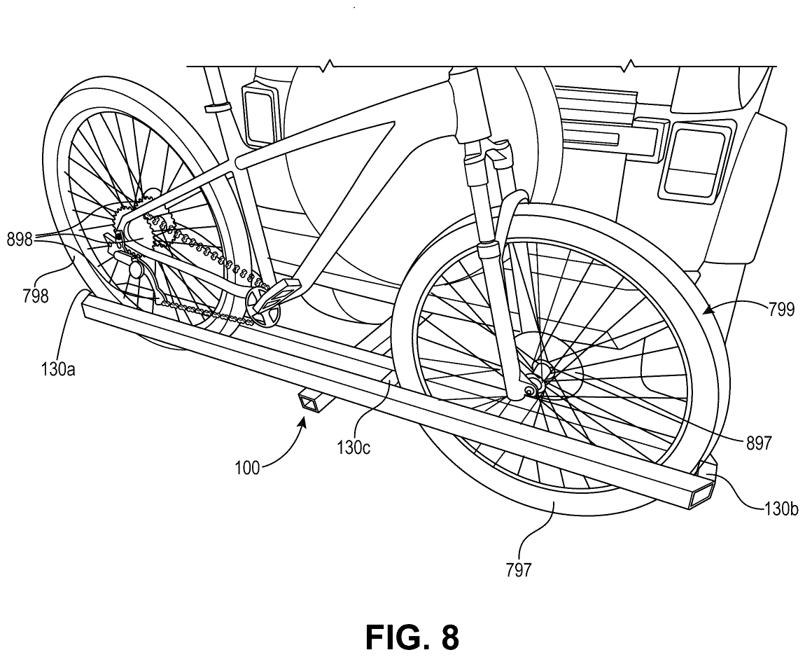

As demonstrated in FIGS. 7 and 8, the length L3 (shown in FIG. 7) can exceed the length L1 (shown in FIG. 5) between the first cross-member 130a and the second cross-member 130b, thereby preventing the bicycle 799 from passing through the slot 121. Additionally, the diameter D1 of the front tire 797 can exceed the length L2 (shown in FIG. 5) between the second cross-member 130b and the third cross-member 130c so that the front tire 797 cannot pass completely between the second cross-member 130b and the third cross-member 130c. Specifically, the length L2 can be sized so that the front tire 797 is positioned sufficiently high above the bicycle rack 100 to prevent contact between potentially fragile components of the bicycle 799, such as front disc brakes 897, and the bicycle rack 100. With the front tire 797 constrained between the second cross-member 130b and the third cross-member 130c, the length L1 can be sized so that contact between the rear tire 798 and the first cross-member 130a can position the rear disc brakes, gears, and/or derailleur 898 of the bicycle 799 sufficiently far above the bicycle rack 100 to prevent contact with the bicycle rack 100.

As shown and described, the bicycle rack 100 can secure the bicycle 799 without the use of any moving pieces, which can be lost, broken, or come loose. However, in some aspects, the bicycle rack 100 can comprise additional components or mechanisms to further secure the bicycle 799 within the bicycle rack 100, such as straps, latches, pins, clasps, or another other suitable mechanisms or components.

In some aspects, a fourth cross-member (not shown) can be positioned to engage with the rear tire 798 as well, which can be similar to the engagement of the second cross-member 130b and the third cross-member 130c with the front tire 797.

In some aspects, the length L1 and the length L2 can be appropriately sized so that bicycles 799 can be received in the bicycle rack 100 in forward and/or reverse orientation (i.e. with the rear tire 798 positioned between the second cross-member 130b and the third cross-member 130c).

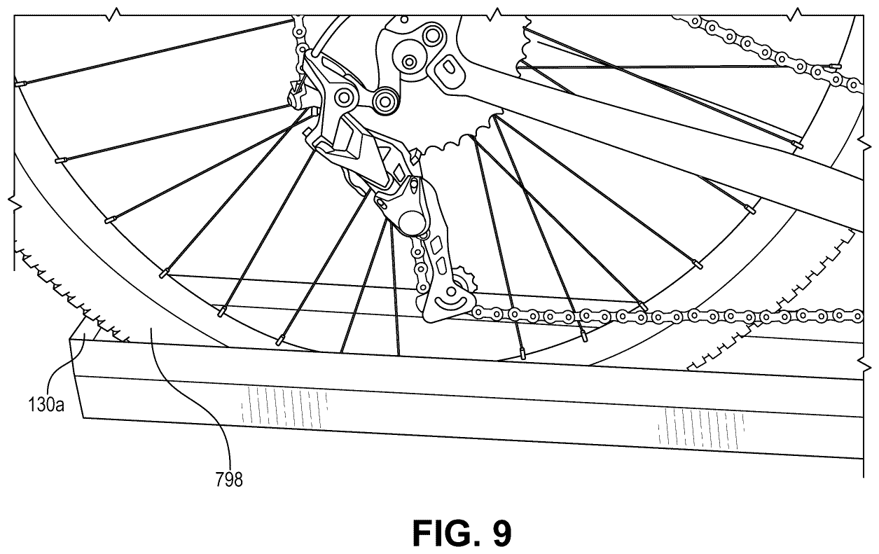

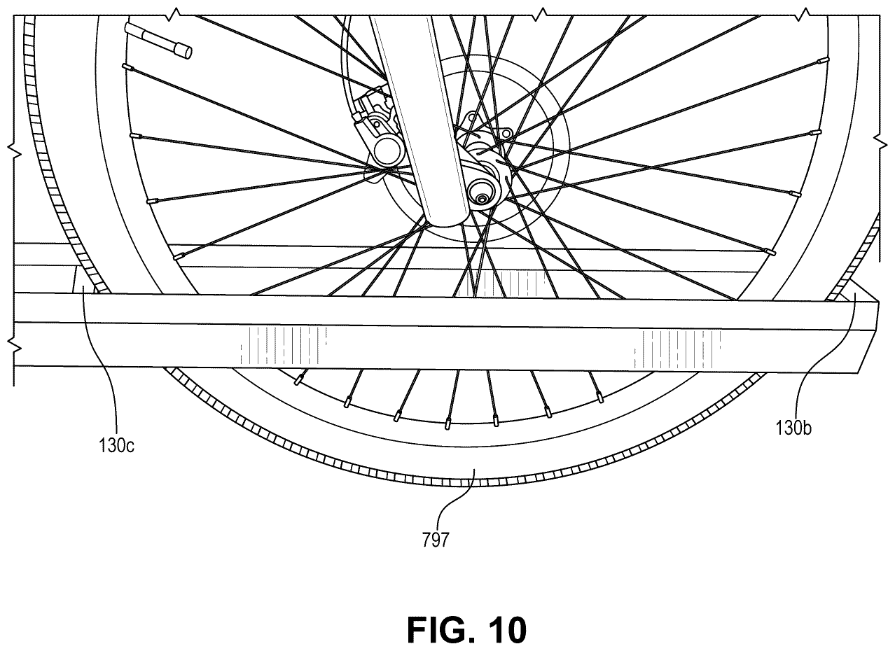

FIG. 9 is a detailed view demonstrating how the rear tire 798 can engage with the first cross-member 130a. FIG. 10 is a detailed view demonstrating how the front tire 797 can engage with the second cross-member 130b and the third cross-member 130c.

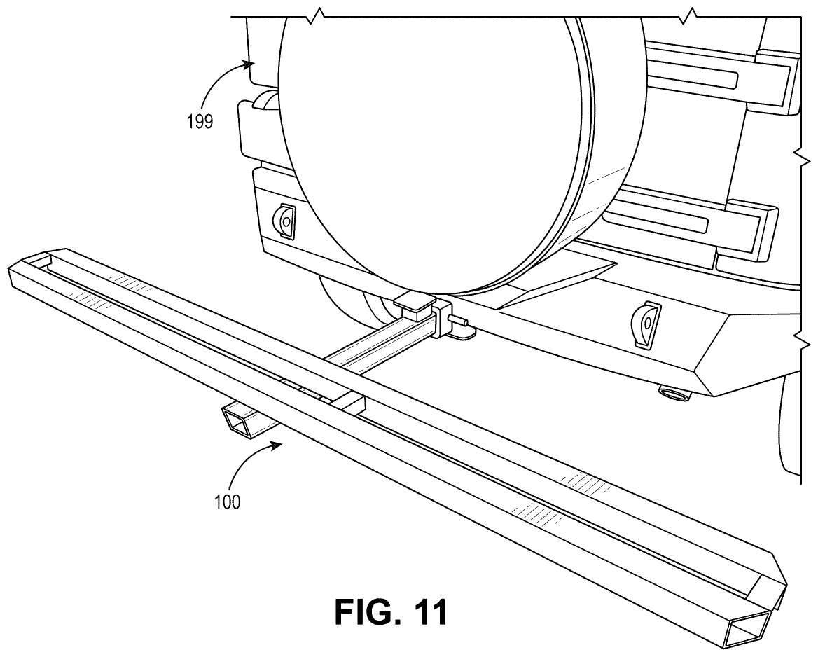

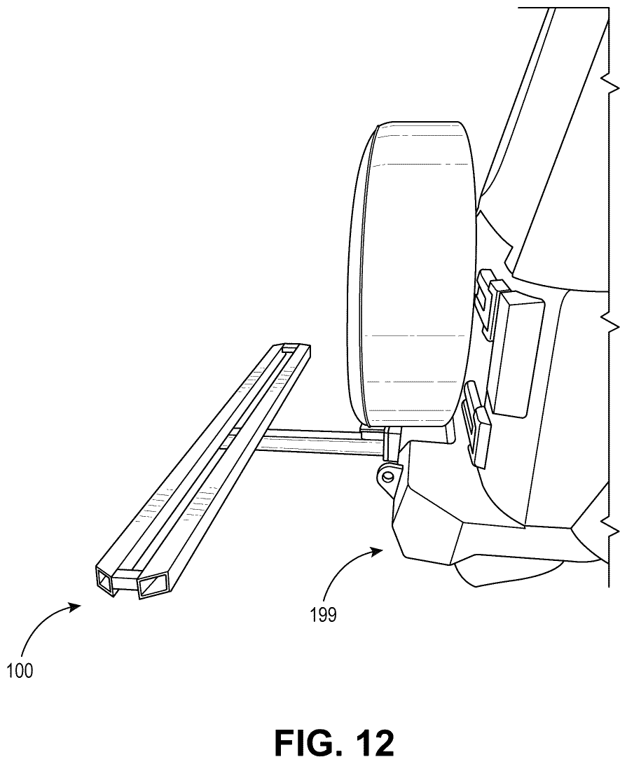

FIGS. 11 and 12 are perspective rear views of the bicycle rack 100 of FIG. 1 coupled to the vehicle 199.

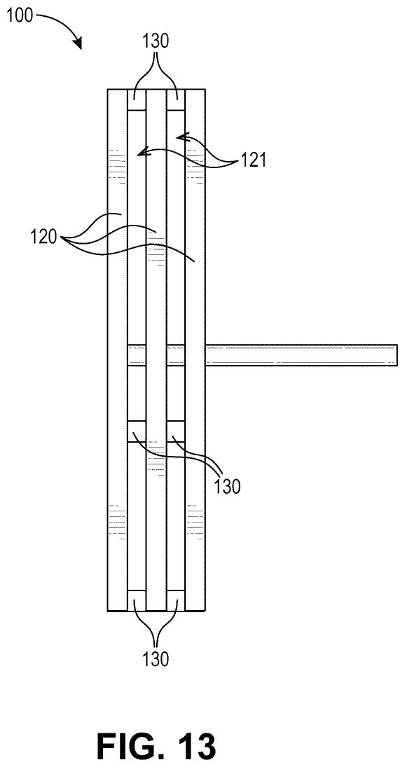

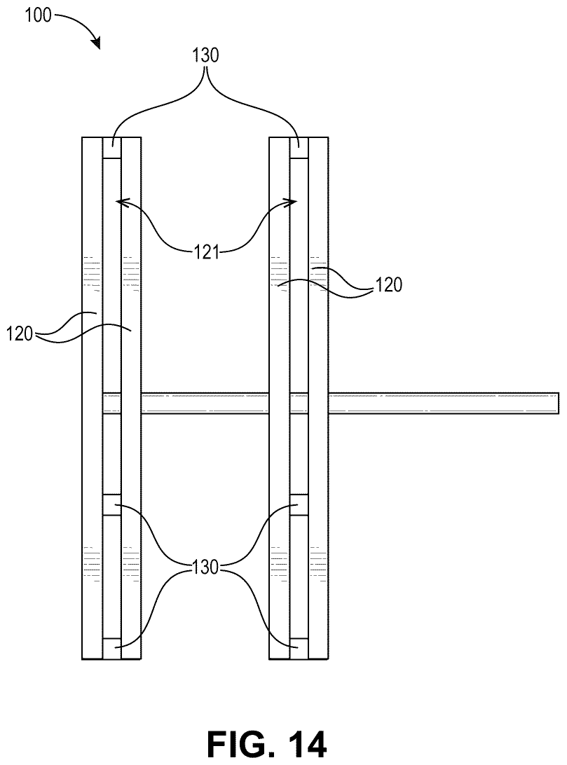

FIG. 13 is a top view of another aspect of the bicycle rack 100, which can comprise three (or more) supporting members 120 connected by cross-members 130. Each pair of adjacent supporting members 120 can define the slot 121, which can be configured to receive a separate bicycle. FIG. 14 is a top view of another aspect of the bicycle rack 100, which can comprise multiple separate pairs of supporting members 120 connected by cross-members 130. Each separate pair of supporting members 120 can define the slot 121, and the slots 121 can be configured to carry separate bicycles spaced apart from one another.

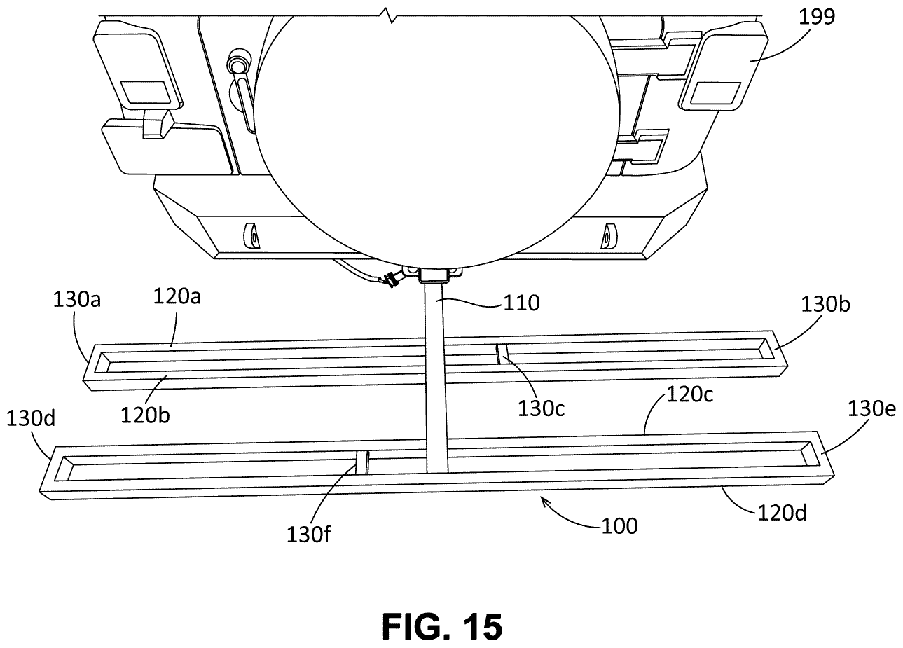

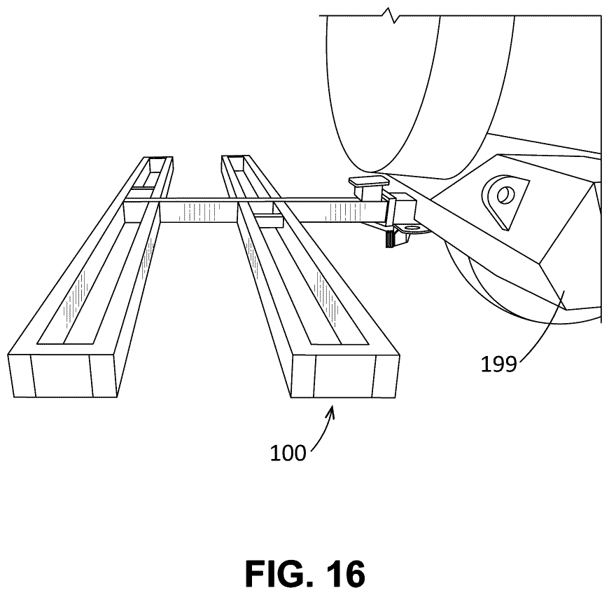

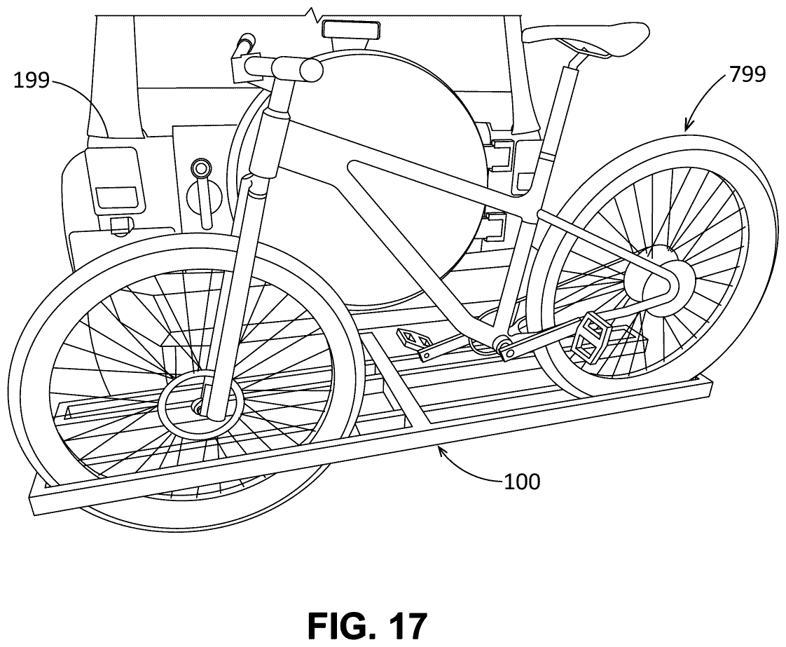

In aspects of the bicycle rack 100 that are configured to carry multiple bicycles, the bicycle racks 100 can be configured to carry the bicycles facing the same direction, as demonstrated by FIGS. 13 and 14, or in opposite directions, as demonstrated by the aspect of the bicycle rack 100 shown in FIGS. 15-17.

As demonstrated in FIG. 15, the bicycle rack 100 can comprise the first supporting member 120a, the second supporting member 120b, a third supporting member 120c, and a fourth supporting member 120d. The bicycle rack 100 can comprise the first cross-member 130a, the second cross-member 130b, the third cross-member 130c, a fourth cross-member 130d, a fifth cross-member 130e, and a sixth cross-member 130f. The cross-members 130a-c can be coupled to the first supporting member 120 a and/or the second supporting member 120b. The cross-members 130d-f can be coupled to the third supporting member 120c and/or the fourth supporting member 120d.

As shown, the third cross-member 130c and the sixth cross-member 130f can be positioned on opposite sides of the coupling member 110. In the aspect shown, the bicycle rack 100 can be configured to receive a first bicycle between supporting members 120a,b with its front tire positioned on the left, and the bicycle rack 100 can be configured to receive a second bicycle between supporting members 120c, d with its front tire positioned on the right.

One should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

It should be emphasized that the above-described aspects are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described aspect(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A bicycle rack comprising:
at least one supporting member at least partially defining a slot, the slot configured to receive a bicycle; and
at least one cross-member further defining the slot.

2. The bicycle rack of claim 1, wherein the slot is defined between a first supporting member of the at least one supporting member and a second supporting member of the at least one supporting member.

3. The bicycle rack of claim 2, wherein the at least one cross-member comprises a first cross-member and a second cross-member, and wherein the first cross-member and the second cross-member each extend at least partially between the first supporting member and the second supporting member.

4. The bicycle rack of claim 3, wherein a first length measured from the first cross-member to the second cross-member is adjustable.

5. The bicycle rack of claim 3, wherein a first length measured from the first cross-member to the second cross-member is sized to be smaller than a length of the bicycle.

6. The bicycle rack of claim 3, wherein the at least one cross-member further comprises a third cross-member, wherein the third cross-member extends at least partially between the first supporting member and the second supporting member, and wherein the third cross-member is positioned between the first cross-member and the second cross-member.

7. The bicycle rack of claim 6, wherein a second length measured from the second cross-member to the third cross-member is sized to be smaller than a diameter of a tire of the bicycle.

8. The bicycle rack of claim 1, wherein a length of the at least one supporting member is adjustable.

9. The bicycle rack of claim 1, wherein a width of the slot is adjustable.

10. The bicycle rack of claim 1, wherein the slot is sized to snuggly grip a tire of the bicycle.

11. The bicycle rack of claim 1, further comprising a coupling member, the coupling member coupled to the at least one supporting member, the coupling member configured to couple the bicycle rack to a vehicle.

12. A bicycle rack assembly comprising:
a bicycle rack comprising:
a first supporting member;
a second supporting member spaced apart from the first supporting member, a slot at least partially defined between the first supporting member and the second supporting member;
a first cross-member extending at least partially between the first supporting member and the second supporting member, the first cross-member further defining the slot;
a second cross-member extending at least partially between the first supporting member and the second supporting member, the second cross-member further defining the slot;
a third cross-member extending at least partially between the first supporting member and the second supporting member, the third cross-member positioned within the slot between the first cross-member and the second cross-member; and
a bicycle comprising a first tire and a second tire, the first tire received in the slot between the first cross-member and the second cross-member, the second tire received in the slot between the second cross-member and the third cross-member.

13. The bicycle rack assembly of claim 12, wherein the first tire is a rear tire, and wherein the second tire is a front tire.

14. The bicycle rack assembly of claim 13, wherein:
the second tire defines a diameter;
a first length is defined between the second cross-member and the third cross-member; and
the first length is smaller than the diameter.

15. The bicycle rack assembly of claim 14, wherein:
the bicycle further comprises a disc brake coupled to the second tire; and
the first length is sized to position the disc brake above the first supporting member and the second supporting member.

16. The bicycle rack assembly of claim 12, wherein:
the bicycle defines a length equal to a furthest distance between the first tire and the second tire;
a second length is defined between the first cross-member and the second cross-member; and
the second length is smaller than the length of the bicycle.

17. The bicycle rack assembly of claim 12, wherein the first tire contacts the first cross-member.

18. The bicycle rack assembly of claim 12, wherein the second tire contacts the second cross-member and the third cross-member.

19. The bicycle rack assembly of claim 12, wherein the slot is sized to snuggly grip the first tire and the second tire.

20. The bicycle rack assembly of claim 12, wherein the bicycle further comprises a derailleur coupled to the first tire, and wherein the derailleur is positioned above the first supporting member and the second supporting member.
